(19) United States
(12) Patent Application Publication
(10) Pub. No.: US 2008/0047578 A1
(43) Pub. Date: Feb. 28, 2008

(54) METHOD FOR PREVENTING CLOGGING OF REACTION CHAMBER EXHAUST LINES

(75) Inventors: Ming-Feng Yoo, Shin-Chu (TW); Jean Wang, Hsin Chu (TW); Jyh-Cherng Sheu, Hsin Chu City (TW)

Correspondence Address: DUANE MORRIS LLP;IP DEPARTMENT (TSMC), 30 SOUTH 17TH STREET, PHILADELPHIA, PA, 19103-4196, US

(73) Assignee: Taiwan Semiconductor Manufacturing Co., Ltd., Hsin-Chu (TW)

(21) Appl. No.: 11/466,922

(22) Filed: Aug. 24, 2006

(51) Int. Cl. B08B 9/02

(52) U.S. Cl. 134/1.1; 15/104.05

(57) ABSTRACT

An apparatus and method are disclosed for cleaning exhaust lines from a reaction chamber used in manufacturing semiconductor devices. In particular, an apparatus is disclosed for receiving an exhaust gas from a semiconductor processing reaction chamber, mixing said exhaust gas with a cleaning gas, exciting the mixture to a plasma state, and pumping the mixture away via an exhaust line. A vacuum pump is provided for pumping the mixture, and a scrubber may be provided to remove particulate and other matter from the gas mixture. Radio-frequency or microwave energy may be used to excite the gas mixture, and the cleaning gas may comprise argon.

### FIELD OF THE INVENTION

The invention relates to methods of cleaning portions of semiconductor reaction chamber lines, and particularly to methods for cleaning reaction chamber exhaust lines using a plasma technique.

### BACKGROUND

As part of a typical chemical vapor deposition (CVD) process, such as nitride deposition or Tetraethyl Orthosilicate (TEOS) deposition, selected gases are input to a reaction chamber for forming thin films on substrates. Such films deposit not only on the substrate, but also on the walls and other exposed surfaces of the reaction chamber. The gases are then pumped out of the reaction chamber through an exhaust line. But because only a small portion of the gases input into the chamber are actually consumed in the deposition process, the gases pumped out through the exhaust line contain compounds that are still in highly reactive states and/or contain residues or particulate matter that can form deposits in the exhaust line. Over time, these deposits can clog the exhaust line if not appropriately cleaned. Even when periodically cleaned, the deposits can interfere with normal operation of the vacuum pump and can shorten the useful life of the pump. Also, it is possible that the deposited material may move from the exhaust line into the processing chamber and contaminate processing steps, thereby reducing wafer yield.

Two techniques have traditionally been used to alleviate the buildup problem. The first technique involves the application of a high temperature tape heater jacket to the outside surfaces of the exhaust lines to prevent the line temperature from dropping below the temperature at which the particulate or other materials may “condense” from the conducted gas. With the tape heating technique, however, it can be difficult or impossible to completely eliminate cold spots along the entire length of the exhaust line, and thus byproduct condensation can still occur. Additionally, maintenance of the high temperature tape can be difficult, and can also pose safety risks (e.g., electrical fire risks). A second technique involves periodically cleaning the lines to eliminate buildup. Cleaning may be performed using hot water and ultrasonic vibration, and, although effective, such cleaning requires the system to be shut down, thus reducing the use efficiency of the reaction chamber.

Thus, there is a need for an improved system and method for maintaining reaction chamber exhaust lines clean and clog-free, while minimizing or eliminating the time that the system must be shut down or “off line.”

### SUMMARY OF THE INVENTION

An apparatus is disclosed for eliminating clogging of a reaction chamber exhaust line. The apparatus may comprise a plasma cleaning unit configured to connect to an exhaust line of a semiconductor processing reaction chamber to receive exhaust gas from said reaction chamber. The plasma cleaning unit further may have a cleaning gas inlet for introducing cleaning gas into the unit for mixing with said exhaust gas. The plasma cleaning unit further may comprise a plasma source for exciting the mixture of received exhaust gas and cleaning gas to decompose the gas mixture into at least two constituent components.

A system is disclosed for maintaining reaction chamber exhaust lines. The system may comprise a plasma cleaning unit, a vacuum pump, and a scrubber. The plasma cleaning unit may comprise an inlet for receiving exhaust gas from a semiconductor processing chamber, and may further have a cleaning gas inlet for introducing cleaning gas into the unit for mixing with said exhaust gas. The plasma cleaning unit further may comprise a plasma source for exciting the mixture of received exhaust gas and cleaning gas to decompose the gas mixture into at least two constituent components. The vacuum pump may be connected to an outlet of said plasma cleaning unit may draw said constituent components of said gas mixture out of said plasma cleaning unit and directing said constituent components to said scrubber.

A method is disclosed for maintaining reaction chamber exhaust lines, said method comprising: directing exhaust gas from a semiconductor reaction to a plasma cleaning unit; directing a cleaning gas to said plasma cleaning unit; mixing said exhaust gas and said cleaning gas within said plasma cleaning unit; exciting the gas mixture into a plasma state; pumping said gas mixture from said plasma cleaning unit through an exhaust line; and directing said gas mixture to a scrubber.

### BRIEF DESCRIPTION OF THE DRAWINGS

These and other features and advantages of the present invention will be more fully disclosed in, or rendered obvious by, the following detailed description of the preferred embodiment of the invention, which is to be considered together with the accompanying drawings wherein like numbers refer to like parts, and further wherein:

FIG. 1 is a schematic view of a reaction chamber and associated piping and components;

FIG. 2 is a schematic view of the system of FIG. 1, incorporating the inventive plasma cleaning system in the exhaust line of the reaction chamber;

FIG. 3 is a schematic view of an exemplary control circuit for an RF plasma generator.

### DETAILED DESCRIPTION

Referring to FIG. 1, a wafer processing system 10 is shown comprising a reaction chamber 12 having a grounded chamber wall 14 and a chamber top 18. Source gases for wafer processing are provided by a gas supply 20. The gas supply 20 is coupled with the reaction chamber 12 through a gas control panel 22, which selects and controls the flow of the source gases into the reaction chamber 12. A semiconductor wafer 34 is supported on a wafer chuck 36 in the reaction chamber 12. Volatile reaction products and unreacted plasma or gas species are removed from the reaction chamber 12 by a gas removal mechanism, such as a vacuum pump 24 through a throttle valve 26.

The reaction chamber 12 may be a CVD chamber, in which gases are introduced into the reaction chamber 12 and a plasma may be formed from the gases in the reaction chamber 12. In a heterogeneous, or surface-catalyzed reaction, the gas or plasma deposits a solid film on the surface of the wafer 34. By regulating the flow of gases from the interior of the reaction chamber 12 to the vacuum pump 24, the throttle valve 26 of the system 10 may be used to control the interior pressures of the reaction chamber 12.

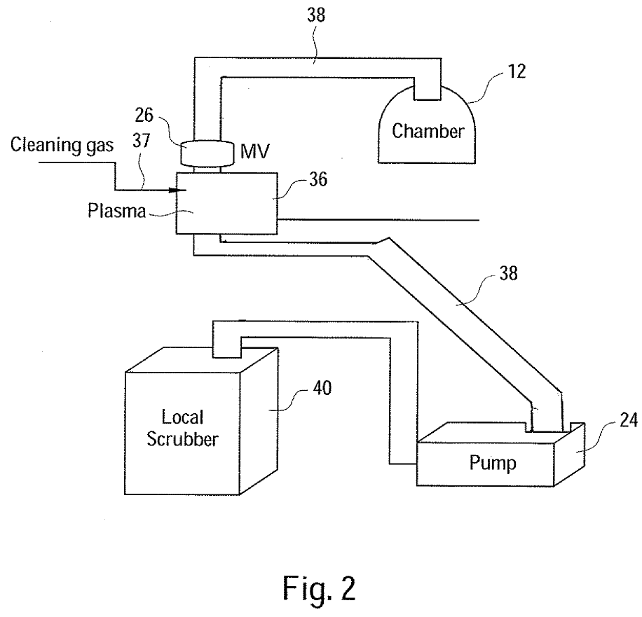

Referring to FIG. 2, a downstream plasma cleaning unit 36 may be installed between the throttle valve 26 and the vacuum pump 24 in a portion of the exhaust line 38 located immediately downstream of the throttle valve 26. Thus arranged, gases removed from the reaction chamber 12 pass though the plasma cleaning unit 36 so that particulate and residue from the gases are treated prior to being deposited on the interior surface of the exhaust line 38 downstream of the plasma cleaning unit 36.

The cleaning gas may be added to the exhaust line 38 upstream of the plasma cleaning unit 36 via a dedicated cleaning gas supply line 37. Alternatively, and as illustrated in FIG. 1, the dedicated cleaning gas supply line 37 may be connected directly to the plasma cleaning unit 36. Appropriate gases may be, for example, Argon, and an appropriate flow rate may be less than 5 standard liters per minute (SLM).

A scrubber 40 may be connected to the discharge side of the vacuum pump 24. In one exemplary embodiment, the scrubber 40 may comprise a wet scrubber employing water. Thus, the scrubber 40 may combine the exhaust gas and its constituents with water to produce various aqueous species that can be treated using well-known waste treatment methods.

Alternatively, the scrubber 40 may comprise a first scrubbing stage comprising a heater element for heating the exhaust gas to a desired elevated temperature, combined with a second scrubbing stage comprising a water scrubbing section. Thus, the first scrubbing section may comprise a high temperature heater element for increasing the temperature of the exhaust gas in the range of about 800 degrees Celsius to about 1000 degrees Celsius. Most exhaust gases (e.g., HCl, HBr, Cl₂, and the like) can be decomposed or oxidized at such elevated temperatures, while still remaining soluble in water, so that they may be more easily removed from the system using the water scrubbing section of the scrubber 40.

When activated, the plasma cleaning unit 36 creates a voltage field that excites molecules of residual matter deposited on the interior surfaces of the unit 36 and molecules of exhaust gases passing through the unit into a plasma state. The plasma enhances decomposition of the matter within unit 36 into gaseous products and byproducts that may be pumped out through the exhaust line thus preventing residue build-up.

For example, in the case where residue build-up within the exhaust line 38 is in the form of ammonium chloride (NH₄Cl), the plasma formed by the plasma cleaning unit 36 breaks the residue down into components such as ammonia (NH₃) and hydrochloric acid HCl.

Thus, an exemplary reaction mechanism may be described according to the formula AB(g)-->A(g)+B(g). For the embodiment in which the residue buildup comprises ammonium chloride, the reaction mechanism is: NH₄Cl-->NH₃(g)+HCl(g) (where the reaction is with Ar gas).

The voltage field created within the plasma cleaning unit 36 for forming the plasma may be generated using a variety of known methods such as radio frequency (RF) or microwave techniques. Where RF techniques are used, the RF power may be set at about 3000 kilo-watts in order to effect a desired byproduct removal.

The plasma cleaning unit 36 may be operated while the chamber cleaning operation in being performed, or it may be operated during the period in which film deposition is occurring within the reaction chamber 12.

It will be appreciated that multiple plasma cleaning units 36 may be installed in a single exhaust line 38 in order to enhance elimination of residue buildup in the exhaust line and vacuum pump 24. Where multiple plasma cleaning units 36 are installed, they may be identical or they may have different operational characteristics. Thus, in one embodiment, different plasma cleaning units 36 may be used in series and/or in parallel in order to remove different constituent byproducts from the exhaust gas. Additionally, where a single reaction chamber 12 is used for multiple processes, multiple different plasma cleaning units 36 may be included in the exhaust line 36, and each may be brought “on line” (or taken “off line”) depending on the process being performed within the reaction chamber so that a desired exhaust byproduct may be removed according to the process being performed.

The plasma cleaning unit 36 may be installed adjacent to the throttle valve 26 of the reaction chamber 12 to decompose the byproduct (which in one embodiment is NH₄Cl) in the exhaust gas. The byproduct may then be condensed and removed via the scrubber 40. An appropriate gas, which in one embodiment is Argon, may then be added for plasma ignition. Argon gas may be supplied from an appropriate container and injected or directed into to the exhaust line 38 upstream of the plasma cleaning unit 36. Alternatively, the gas may be supplied directly to the plasma cleaning unit 36 (as shown in FIG. 2). Plasma ignition turns the Argon molecules into an Argon ions, so that they may collide with the targeted byproduct(s), thus decomposing the byproducts as they passing through the plasma cleaning unit 36. Employing one or more plasma cleaning units 36 thus ensures that unwanted byproducts will not condense in the exhaust line 38, but rather will be separated out (i.e., condensed) in the scrubber 40.

One substantial advantage afforded by the plasma cleaning unit 10 is that it works to maintain the process chamber servo at stable pressure for production. To do this, the generator 36 must be capable of reacting to the changing characteristics of the plasma, thus ensuring that power remains stable during operation. This is because the plasma generator 36 is used to ignite and maintain a plasma that may vary continuously, and/or that may or may not be stable. Thus, a high degree of control is required in order to maintain such balance or stability during operation.

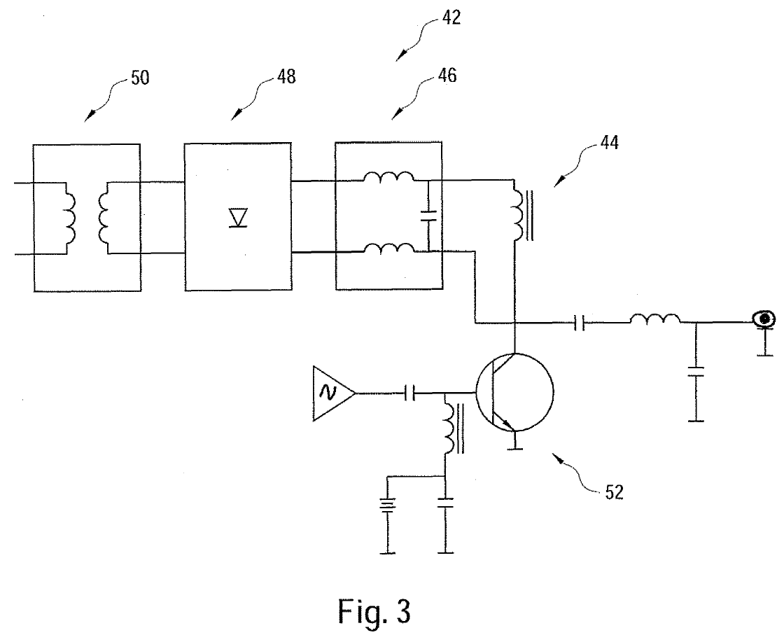

FIG. 3 shows an exemplary control circuit 42 for use with an RF plasma generator. Specifically, the control circuit illustrated in FIG. 3 comprises a DC power source 44, DC filter 46, diode bridge 48, transformer 50, and a solid state RF linear amplifier 52. In one embodiment, the DC power source a 50 Volts DC power source, and the transformer is a 60 Hz transformer.

In addition to preventing clogging of the exhaust line 38, the plasma cleaning unit 36 may eliminate or reduce pump and local scrubber clogging, which may cause undesirable backpressure in the process chamber exhaust lines 38. Such pump and scrubber clogging may interrupt production, and ultimately may lead to undesirable wafer scrap. Additionally, the plasma cleaning unit 10 reduces the total manpower required to maintain the pumping system operational, and reduces vacuum leakage resulting from out-gassing of exhaust gas byproducts.

While the foregoing invention has been described with reference to the above embodiments, various modifications and changes can be made without departing from the spirit of the invention. Accordingly, all such modifications and changes are considered to be within the scope and range of equivalents of the appended claims.

1. An apparatus for eliminating clogging of a reaction chamber exhaust line, said apparatus comprising:
a plasma cleaning unit configured to connect to an exhaust line of a semiconductor processing reaction chamber to receive exhaust gas from said reaction chamber, the plasma cleaning unit having a cleaning gas inlet for introducing cleaning gas into the unit for mixing with said exhaust gas;
wherein said plasma cleaning unit further comprises a plasma source for exciting the mixture of received exhaust gas and cleaning gas to decompose the gas mixture into at least two constituent components.

2. The apparatus of claim 1, wherein said plasma source comprises a radio frequency (RF) source.

3. The apparatus of claim 1, wherein said plasma source comprises a microwave source.

4. The apparatus of claim 1, further comprising a vacuum pump in fluid connection with an outlet of said plasma cleaning unit further for directing the constituent components of the gas mixture away from the plasma cleaning unit.

5. The apparatus of claim 4, further comprising a scrubber in fluid connection with an outlet of said vacuum pump, said scrubber operable to remove particulate matter from the gas mixture.

6. The apparatus of claim 5, wherein said scrubber comprises a wet scrubber.

7. The apparatus of claim 1, wherein said cleaning gas comprises argon, said exhaust gas comprises ammonium chloride, and said constituent components comprise ammonia and hydrochloric acid.

8. A system for maintaining reaction chamber exhaust lines, said system comprising:
a plasma cleaning unit;
a vacuum pump; and
a scrubber;
wherein said plasma cleaning unit comprises an inlet for receiving exhaust gas from a semiconductor processing chamber, the plasma cleaning unit further having a cleaning gas inlet for introducing cleaning gas into the unit for mixing with said exhaust gas, said plasma cleaning unit further comprising a plasma source for exciting the mixture of received exhaust gas and cleaning gas to decompose the gas mixture into at least two constituent components; said vacuum pump connected to an outlet of said plasma cleaning unit for drawing said constituent components of said gas mixture out of said plasma cleaning unit and for directing said constituent components to said scrubber.

9. The apparatus of claim 8, wherein said plasma source comprises a radio frequency (RF) source.

10. The apparatus of claim 8, wherein said plasma source comprises a microwave source.

11. The apparatus of claim 8, wherein said scrubber removes particulate matter from the gas mixture.

12. The system of claim 11, wherein said scrubber comprises a wet scrubber.

13. The system of claim 8, wherein said exhaust gas comprises ammonium chloride, and said constituent components comprise ammonia and hydrochloric acid.

14. The system of claim 13, wherein said cleaning gas comprises argon.

15. A method for maintaining reaction chamber exhaust lines, said method comprising:
directing exhaust gas from a semiconductor reaction to a plasma cleaning unit;
directing a cleaning gas to said plasma cleaning unit;
mixing said exhaust gas and said cleaning gas within said plasma cleaning unit;
exciting the gas mixture into a plasma state;
pumping said gas mixture from said plasma cleaning unit through an exhaust line; and
directing said gas mixture to a scrubber.

16. The method of claim 15, wherein the step of exciting the gas mixture comprises subjecting the gas mixture to a radio frequency (RF) source.

17. The method of claim 15, wherein the step of exciting the gas mixture comprises subjecting the gas mixture to a microwave source.

18. The method of claim 15, wherein the step of pumping said gas mixture is performed using a vacuum pump in fluid connection with an outlet of said plasma cleaning unit to direct the gas mixture away from the plasma cleaning unit.

19. The method of claim 15, further comprising the step of scrubbing said gas mixture to remove particulate matter from the gas mixture.

20. The method of claim 19, wherein said step of scrubbing said gas mixture comprises using a wet scrubber.
